(19) United States
(12) Patent Application Publication
(10) Pub. No.: US 2022/0007705 A1
(43) Pub. Date: Jan. 13, 2022

(54) SPRING ROLL FILLINGS, HEAT COOKING SPRING ROLL, AND MANUFACTURING METHOD THEREOF

(71) Applicant: NICHIREI FOODS INC., Tokyo-to (JP)

(72) Inventors: Miho MIYAJIMA, Chiba-shi (JP); Fumiko SUEMASA, Chiba-shi (JP)

(73) Assignee: NICHIREI FOODS INC., Tokyo-to (JP)

(21) Appl. No.: 17/487,561

(22) Filed: Sep. 28, 2021

Related U.S. Application Data
(63) Continuation of application No. PCT/JP2020/013974, filed on Mar. 27, 2020.

(30) Foreign Application Priority Data
Mar. 29, 2019 (JP) 2019-067831

(51) Int. Cl. A23P 20/25; A23L 7/109; A21D 13/60

(52) U.S. Cl. CPC A23P 20/25; A21D 13/60; A23L 7/11

(57) ABSTRACT

The present invention provides a novel heat cooking spring roll in which the crispness of the spring roll skin after deep-frying is retained. More specifically, as fillings for the spring roll, there are used fillings in which a first filling and a second filling are included, at least a part of the surface of the first filling is covered with the second filling, and the moisture value of the second filling is lower than that of the first filling.

### CROSS REFERENCE TO RELATED APPLICATIONS

The present patent application claims priority based on Japanese Patent Application No. 2019-67831 filed on Mar. 29, 2019, and the whole discloses of the earlier patent application are hereby incorporated by reference as a part of this description.

### TECHNICAL FIELD

The present invention relates to novel spring roll fillings, spring roll for heat cooking, and a manufacturing method thereof.

### BACKGROUND ART

In general, it is desired that spring rolls have both textures of crispness and softness at the same time respectively for the spring roll skin and the fillings wrapped by the skin. Ordinarily, such a texture can be obtained in spring rolls immediately after deep-fried.

However, when the deep-fried spring roll is freeze-stored or time elapses between deep-frying and eating of the spring roll, water content in the fillings and the like is transferred to the spring roll skin to reduce the crispness of the spring roll skin. Further, it is known that such texture is significantly impaired by reheating using a microwave oven or the like.

Accordingly, there has been so far studied and developed a method of forming a barrier layer in the spring roll skin and thus preventing the water content of the filling from being transferred to the skin. Examples of the method include a method of providing fillings, coat dough covering the fillings, and a barrier layer covering the fillings between the fillings and the coat dough (Patent Document 1), and a method of providing a mixture of an oil-absorbing substance and oil or fat between the noodle belt and the filling (Patent Document 2).

In addition, there is also proposed a method for producing spring rolls, which includes a shaping step of shaping a spring roll by wrapping fillings with a spring roll skin, a drying step of drying the spring roll so that the water content of the spring roll is 28% by mass or less, and a deep-frying step of deep-frying the dried spring roll (Patent Document 3).

There is also proposed a method of using fillings and a skin portion that wraps the fillings as a food for wrapped fried cooking, and at least one part of the skin portion has a layered structure of 10 or more skin layers (Patent Document 4).

There is also proposed a method of using a composition for a skin of a fried spring roll in which the composition contains flour and swelling-inhibiting starch having a swelling degree of 5 or less, and the content ratio of the swelling-inhibiting starch is 2 to 70% by mass with respect to the total amount of flour and swelling-suppressing starch (Patent Document 5).

Furthermore, it is also considered to reduce the moisture value of the filling of spring rolls. However, merely reducing the moisture value causes a problem of reduction in thickness peculiar to spring rolls and thus great reduction of the quality.

Under above technical situation, there is still required a means to retain the crispness of the spring roll skin after deep-frying.

### PRIOR ART DOCUMENT

### Patent Document

[Patent Document 1] WO 2007/013314 A1
[Patent Document 2] JP 2006-271287 A
[Patent Document 3] JP 2015-195758 A
[Patent Document 4] JP 2012-213371 A
[Patent Document 5] JP 2003-199518 A

### SUMMARY OF THE INVENTION

The present invention provides a spring roll for heat cooking (hereinafter, also simply referred to as a spring roll) in which the crispness of the spring roll skin after deep-fry cooking is retained.

The present inventors have recently found that the crispness of the spring roll skin after deep-fry cooking (hereinafter, also simply referred to as deep-frying) is retained when there are used spring roll fillings in which at least a part of the surface of the conventional filling (first filling) is covered with a second filling having a lower moisture value than that of the first filling.

According to the present invention, the following inventions are provided.

[1] Fillings for spring rolls, comprising a first filling and a second filling,

wherein at least a part of the surface of the first filling is covered with the second filling, and

wherein the moisture value of the second filling is lower than the moisture value of the first filling.

[2] The fillings according to [1], wherein the second filling contains a mixture of oil or fat and wheat.
[3] The fillings according to [1], wherein the second filling contains a kneaded mixture of wheat and water.
[4] The fillings according to [1], wherein the second filling is a spring roll skin.
[5] An unheated spring roll for heat cooking, which is shaped by wrapping the fillings according to any one of [1] to [4] with a spring roll skin.
[6] A heat cooked spring roll, which is a heat cooked product of the spring roll according to [5].
[7] The spring roll according to [5] or [6], which is a frozen food.
[8] The unheated spring roll for heat cooking according to [5] or [7], wherein the difference in moisture value between the first filling and the second filling is 40% by mass or more.
[9] A heat cooked spring roll of the spring roll according to [5] or [7], or the heat cooked spring roll according to [6], wherein the relationship among moisture values after deep-frying, A (mass %) for the first filling, B (mass %) for the second filling, and C (mass %) for the innermost layer of the spring roll skin, is represented by A>B≥C.
[10] A method for producing a spring roll for heat cooking obtained by wrapping fillings with a spring roll skin to shape,

comprising a step of forming fillings,
wherein the fillings include a first filling and a second filling,
wherein at least a part of the surface of the first filling is covered with the second filling, and

wherein the moisture value of the second filling is lower than the moisture value of the first filling, and wherein the step of forming fillings including a step of covering at least a part of the first filling with the second filling.

[11] The production method according to [10], wherein the second filling contains a mixture of oil or fat and wheat.
[12] The production method according to [10], wherein the second filling contains a kneaded mixture of wheat and water.
[13] The production method according to [10], wherein the second filling is a spring roll skin.
[14] The production method according to any one of [10] to [13], further comprising a step of shaping by wrapping the fillings with a spring roll skin after the step of forming fillings.
[15] The production method according to [14], wherein the shaping step is a step of shaping by wrapping the fillings with a spring roll skin so that at least a part of the spring roll skin has a plurality of layers.
[16] The production method according to [14] or [15], wherein the difference in moisture value between the first filling and the second filling after the shaping step and before deep-fry cooking is 40% by mass or more.
[17] A method for retaining crispness of a spring roll skin after deep-fry cooking of a spring roll for heat cooking which is obtained by wrapping fillings with a spring roll skin to shape, wherein the fillings include a first filling and a second filling,

comprising a step of covering at least a part of the surface of the first filling with the second filling having a moisture value lower than that of the first filling.

According to the present invention, the crispness of the spring roll skin of a spring roll after deep-frying can be retained. Further, the spring rolls of the present invention are advantageous in that the deliciousness can be retained without impairing thickness of the contents (particularly, the first filling).

### DETAILED DESCRIPTION OF THE INVENTION

### Fillings

The spring roll fillings of the present invention include a first filling and a second filling, and at least a part of the surface of the first filling is covered with the second filling. One of the features is that the moisture value of the second filling is lower than the moisture value of the first filling.

### First Filling

The first filling used in the present invention is not particularly limited as long as it does not disturb the effect of the present invention, and usually includes the filling used for spring rolls. Examples of the first filling of the present invention include processed and/or cooked meats, seafoods, vegetables, mushrooms, bean-starch vermicelli, dairy products, fruits, seasonings, spices and the like.

The moisture value before deep-frying of the first filling of the spring rolls for heat cooking of the present invention is not particularly limited as long as it does not disturb the effect of the present invention, and is, for example, 60% by mass or more, preferably 60 to 95% by mass, and more preferably 70 to 95% by mass. Here, the spring roll before deep-frying is a spring roll shaped by wrapping the fillings with a spring roll skin, and means the spring roll before deep-fry cooking. Therefore, the heat-cooking spring rolls before deep-frying are, for example, unheated spring rolls for heat cooking.

The moisture value of each component in spring rolls can be measured by loss on drying test. Such a measurement can be easily performed by using a commercially available device (for example, SMART6 (trademark), manufactured by CEM Japan).

The moisture value after deep-frying of the first filling of the spring rolls of the present invention is not particularly limited as long as it does not disturb the effect of the present invention, and is, for example, 50% by mass or more, preferably 50 to 90% by mass, and more preferably 65 to 90% by mass. When the moisture value is 65% by mass or more, the spring rolls after deep-frying are preferable in that the deliciousness can be retained without impairing thickness of the first filling. Here, the spring roll after deep-frying means a spring roll which is shaped by wrapping the fillings with a spring roll skin and then deep-fry cooked. Therefore, the spring rolls after deep-frying are, for example, heat cooked spring rolls. In addition, the moisture value of spring rolls after deep-frying can be measured by using each part of the spring roll which is decomposed and frozen at −20° C. within 5 minutes after deep-frying in order to suppress the change in moisture value before measurement.

### Second Filling

The second filling used in the present invention is not particularly limited as long as it does not disturb the effect of the present invention, and the moisture value of the second filling is lower than that of the first filling.

The moisture value before deep-frying of the second filling of the spring roll of the present invention is lower than that of the first filling. The difference in moisture value before deep-frying between the second filling and the first filling of the spring roll is, for example, 40% by mass or more, preferably 45% by mass or more, and more preferably 50% by mass or more. Further, the difference in moisture value before deep-frying between the second filling and the first filling of the spring roll may be, for example, 40% by mass to 95% by mass.

The moisture value after deep-frying of the second filling of the spring roll of the present invention is lower than that of the first filling. The difference in moisture value after deep-frying between the second filling and the first filling of the spring roll is, for example, 40% by mass or more, preferably 45% by mass or more, and more preferably 50% by mass or more. Further, the difference in moisture value after deep-frying between the second filling and the first filling of the spring roll may be, for example, 40% by mass to 95% by mass.

The moisture value before deep-frying of the second filling of the spring roll of the present invention is not particularly limited as long as it does not disturb the effect of the present invention, and is, for example, 40% by mass or less, preferably 35% by mass or less, more preferably 30% by mass or less. The moisture value before deep-frying of the second filling of the spring roll may be, for example, 1% by mass to 40% by mass.

The moisture value after deep-frying of the second filling of the spring roll of the present invention is not particularly limited as long as it does not disturb the effect of the present invention, and from the viewpoint of the texture of spring rolls after deep-frying, for example, is 40% by mass or less, preferably 35% by mass or less, and more preferably 30% by mass or less. The moisture value after deep-frying of the second filling of the spring roll may be, for example, 1% by mass to 40% by mass.

The second filling used in the present invention is not particularly limited as long as it does not disturb the effects of the present invention, and may or may not be the one having fluidity at room temperature, for example, the one that is hard to flow out during heating and/or during storage. Here, having no fluidity means that when left at room temperature, the second filling does not flow and maintains its shape retention. Examples of the second filling of the present invention includes a mixture of oil or fat and wheat, a kneaded mixture of wheat and water (for example, dough), a spring roll skin, grain flour only, a moisture value-reduced first filling, and dry bean-starch vermicelli.

The mixture of oil or fat and wheat in the present invention is, for example, the one prepared by adding oil or fat and, if necessary, an emulsifier to flour and mixing them. The oil or fat may be solid oil or fat (including semi-solid oil or fat) or liquid oil or fat, and the specific examples include vegetable oil or fat such as shortening, soybean oil, sesame oil, rapeseed oil, rice oil, palm oil, palm kernel oil, olive oil, coconut oil, corn oil, safflower oil, cottonseed oil, sunflower oil, kapok oil, peanut oil, cacao butter, shea butter, and hard butter (for example, Melanostar Soft (Fuji Oil Co., Ltd.)), or animal oil or fat such as fish oil (for example, sardine oil, menhaden oil, herring oil, shark liver oil, cod liver oil, walleye pollock liver oil), whale oil, beef fat, lard, and butter fat, and these can be used alone or as a mixture. When the oil or fat is contained, the content ratio is, for example, 50 to 90% by weight, preferably 65 to 85% by weight, based on the total amount of the mixture of oil or fat and wheat. Preferred examples of the emulsifier include propylene glycol alginate, glycerin fatty acid ester, sucrose fatty acid ester, sorbitan fatty acid ester, propylene glycol fatty acid ester and the like.

The kneaded mixture of wheat and water (for example, dough) in the present invention is preferably a dough mainly composed of wheat, for example, the one prepared by mixing and kneading flour with the followings or mixtures of the followings: water, and, as needed, vegetable oil or fat such as shortening, soybean oil, sesame oil, rapeseed oil, rice oil, palm oil, olive oil, and the like, and emulsified oil or fat (for example, Satellite (NOF Corp.), Ematec (trademark) (RIKEN VITAMIN CO., LTD.), Grandelica (trademark) (Fuji Oil Co., Ltd.), VEEKREME (trademark) (Nestle Japan Ltd.), and the like). Specific examples include a kneaded mixture of flour and water; a kneaded mixture of flour, water and emulsified oil or fat; a kneaded mixture of flour, water, emulsified oil or fat and other oil or fat. The mixing ratio of wheat and water is, for example, 10 to 60 parts by mass of water, and preferably 20 to 50 parts by weight, based on 100 parts by mass of wheat.

Examples of wheat used in the second filling of the present invention include wheat flour such as strong flour, semi-strong flour, medium flour, soft flour, durum flour, and graham flour. In addition to wheat flour, there may be mixed the followings: grain flour such as buckwheat flour, rice flour, corn flour, semolina flour, corn grits, barley flour, rye flour, adlay flour, barnyard millet flour, and foxtail millet flour; starch such as tapioca starch, potato starch, sweet potato starch, tapioca starch, corn starch, waxy corn starch, wheat starch, rice starch and the like, and processed starch materials such as processed starch (for example, pregelatinized starch, acetate processed starch, phosphate processed starch, etc.) which is obtained by subjecting above starch powders to treatments such as pregelatinization, etherification, esterification, acetylation, cross-linking treatment, oxidation treatment and the like, wet-heat treated starch, and the like.

The moisture value-reduced first filling of the present invention is exemplified by a first filling in which the moisture value is reduced by drying, heating and the like to give the above-mentioned moisture value before deep-frying of the second filling.

Here, when the moisture value of the second filling is high, the moisture value of the second filling may be decreased by deep-frying or heating in an oven.

In the present invention, the second filling is provided on at least a part of the surface of the first filling, and preferably in particular, the second filling covers at least a part of the surface of the first filling, for example, the entire surface. Further, the second filling is in contact with at least a part of the surface of the first filling, and preferably the entire surface. According to one aspect of the present invention, when the second filling is a hot melt filling such as oil or fat, the second filling before deep-frying may cover at least a part of the surface of the first filling as long as the second filling is spread by heating during deep-frying to cover the entire surface of the first filling. Examples of such an aspect include an aspect of covering the first filling during deep-frying over the top surface, the bottom surface, or the like.

The use of the second filling of the present invention is an elaboration on fillings. Therefore, with respect to the point in which a conventional layer for preventing the transfer of water content causes a sense of discomfort, the second filling of the present invention is advantageous in that the discomfort can be eliminated by flavoring of the second filling or the like.

Further, in the present invention, provision of a water content gradient in the filling that is most likely to transfer water content can presumably suppress the transfer of water content of the filling to the skin, resulting in great improvement in the retention of crispness of the skin during storage. In addition, by covering the first filling of much water content with the second filling of low water content, the transfer of the water content of the first filling to the skin is presumably suppressed during deep-frying, and then the skin itself becomes easy to fry.

### Spring Roll Skin

As the spring roll skin of the present invention, the spring roll skin used for ordinary spring rolls can be used. Generally, the spring roll skin is produced through a step of kneading various raw materials and water to prepare a fluid spring roll skin dough and a step of baking the dough. The dough can be baked according to a conventional method, for example, by applying the fluid dough in a film form on a rotating heating drum.

Grain flours are used as the main raw material for spring roll skins. As the grain flours, those usually used as the main raw material for spring roll skins can be used without any particular limitation, and the examples include flours such as soft flour, medium flour, and strong flour, and grain flour such as buckwheat flour, rice flour, corn flour, barley flour, rye flour, adlay flour, barnyard millet flour, and foxtail millet flour; starch such as tapioca starch, potato starch, corn starch, waxy corn starch, wheat starch, rice starch and the like, and processed starch which is obtained by subjecting above starch powders to treatments such as pregelatinization, etherification, esterification, acetylation, cross-linking treatment, oxidation treatment and the like, and one of these can be used alone or in combination of two or more.

As the raw material for the spring roll skin, other raw materials can be used as needed in addition to the grain flour. The other raw material is not particularly limited as long as it is usually used as a raw material for spring roll skin and does not disturb the effect of the present invention, and the examples include egg white, egg yolk, milk, wheat protein, pigment, polysaccharide thickener (locust bean gum, gellan gum, guar gum, xanthan gum, carrageenan, and the like), amino acids (alanine, glycine, lysine, and the like), oil or fat, salt, emulsifier, and the like, and these can be used by one alone or two or more in combination.

The spring roll of the present invention is a spring roll for heat cooking, which is shaped by wrapping fillings with a spring roll skin. The spring roll skin of the present invention preferably has a plurality of layers as the skin portion, more preferably two or more layers over at least a part of the skin portion, and further preferably 2 to 7 layers.

The multi-layer structure may be formed by wrapping the fillings with one spring roll skin a plurality of times, or may be formed by wrapping the fillings with a plurality of spring roll skins.

The innermost layer of the spring roll skin of the spring roll of the present invention has preferably a moisture value after deep-frying equal to or lower than that of the second filling. The difference in moisture value after deep-frying between the innermost layer of the spring roll skin and the second filling is, for example, 5% by mass or more, preferably 5 to 40% by mass, and more preferably 10 to 40% by mass.

Further, in the spring roll after deep-frying, moisture values A for the first filling, B for the second filling, and C (mass %) for the innermost layer of the spring roll skin preferably have a relationship represented by A>B≥C.

The moisture value before deep-frying of the innermost layer of the spring roll skin of the present invention is not particularly limited as long as it does not disturb the effect of the present invention, and may be 10 to 30% by mass, preferably 10 to 25% by mass.

The moisture value after deep-frying of the innermost layer of the spring roll skin of the present invention is not particularly limited as long as it does not disturb the effect of the present invention, and from the viewpoint of the texture of spring roll after deep-frying, is 30% by mass or less, and preferably 0.5 to 30% by mass.

The spring roll for heat cooking according to the present invention may be an unheated spring roll shaped by wrapping fillings with a spring roll skin, which can be frozen. Therefore, the spring roll for heat cooking of the present invention may be a frozen food. The freezing conditions can be appropriately selected from the known conditions, and are preferably −10° C. to −35° C.

The heat cooked spring roll of the present invention is a heat cooked product of the above-mentioned spring roll for heat cooking of the present invention, and can be obtained by heat cooking the spring roll for heat cooking. Such heat cooking includes deep-fry cooking, and is preferably deep-fry cooking. The conditions for deep-fry cooking can be appropriately selected from the known conditions, and are, for example, using oil such as soybean oil at 150 to 200° C. for 1 to 20 minutes.

The heat cooked spring roll of the present invention is a deep-fry cooked product of the above-mentioned spring roll for heat cooking of the present invention, and may be frozen for storage after deep-fry cooking. Therefore, the heat cooked spring roll of the present invention may be a frozen food. The freezing conditions are as described above.

For the heat cooked spring roll of the present invention, the frozen food can be reheated by, for example, microwave heating and then served to eat.

The heat cooked spring roll of the present invention can be obtained by deep-frying the above-mentioned spring roll for heat cooking of the present invention and also be served to eat after stored in a warmer. The storage conditions of the warmer can also be appropriately selected from the known conditions.

### Production Method

The method for producing a spring roll for heat cooking according to the present invention includes a step of forming fillings to cover at least a part of the surface of the first filling with the second filling, preferably the entire surface. The first filling may be frozen. The method for producing a spring roll for heat cooking according to the present invention may further include a step of shaping by wrapping the fillings obtained with a spring roll skin after the step of forming fillings.

The step of forming fillings in the production method of the present invention is not particularly limited as long as it includes a step of covering at least a part of the surface of the first filling with the second filling.

In the method for producing the spring roll for heat cooking according to the present invention, the step of shaping by wrapping fillings with a spring roll skin is a usual shaping method, and is not particularly limited as long as the fillings can be wrapped to cover whole the fillings. According to one aspect of the present invention, the shaping step may be a step of shaping by wrapping fillings with a spring roll skin to make a plurality of layers.

The production method of the present invention may further include a step of deep-frying following the step of shaping by wrapping fillings with a spring roll skin. The conditions for deep-frying are as described above.

The moisture value after deep-frying of the second filling of the spring roll is, for example, 40% by mass or less, and the moisture value after deep-frying of the innermost layer of the spring roll is 30% by mass or less.

According to one aspect of the production method of the present invention, after the step of shaping a spring roll by wrapping fillings with a spring roll skin, the spring roll can be frozen before the above deep-frying. According to another aspect of the production method of the present invention, after the step of shaping a spring roll by wrapping fillings with a spring roll skin and then deep-frying as mentioned above, the spring roll can be frozen. The freezing conditions are as described above. Further, after freezing, reheating may be performed by, for example, microwave oven heating.

According to another aspect of the production method of the present invention, the spring roll may be stored in a warmer after deep-frying.

Further, according to another aspect of the present invention, there is provided a method for retaining the crispness of the spring roll skin after cooking of the spring roll for heat cooking, which is obtained by wrapping fillings with a spring roll skin to shape, wherein the fillings include a first filling and a second filling, and the second filling, which has a moisture value lower than that of the first filling, covers at least a part of the surface of the first filling.

Any of the above-mentioned aspects of the method for retaining the crispness can be embodied in accordance with the description of the present invention regarding the fillings, the spring roll for heat cooking, the heat cooked spring roll and the production method.

### EXAMPLES

Hereinafter, the present invention will be described in more detail with reference to Examples and Comparative Examples, but the technical scope of the present invention is not limited to these examples. Unless otherwise specified, all percentages and ratios used in the present invention are in terms of mass.

### Moisture Value Measurement Method

The moisture value was measured using a water analyzer (SMART6 (trademark), manufactured by CEM Japan).

### Preparation Example 1

### Preparation of the First Filling

The first filling was prepared as follows: pork (100 g), boiled bamboo shoots (shreds, 500 g), leek (2-3 cm cuts, 100 g), and bean sprouts (300 g) were fried with oil (3 tablespoons), then seasoned with sugar (2 teaspoons), salt (⅓ teaspoon), soy sauce (1 tablespoon), sake (2 tablespoons), and a little pepper, thickened with processed starch, and cooled. The moisture value after preparation of the first filling was 85% by mass. The mass of the first filling used in the following examples and comparative examples was 25 g.

### Preparation Example 2

### Preparation of Spring Roll Skin

As a spring roll skin (hereinafter, also simply referred to as a skin), a commercially available spring roll skin (spring roll skin, manufactured by Moranbong) was used. The moisture value of the skin was 19.0% by mass.

### Comparative Example 1

1) The first filling obtained in Preparation Example 1 was placed on the skin, and a spring roll was shaped. At least a part of the skin has formed 7 layers.

### Comparative Example 2

1) A mixture of rapeseed oil and flour (rapeseed oil:flour=80 parts by mass: 20 parts by mass) was prepared.
2) The mixture (7 g) obtained in 1) was applied to the skin at a ratio of about 2.5 g/100 cm².
3) Next, the first filling obtained in Preparation Example 1 was placed on the coated surface side of the skin, and a spring roll was shaped.

### Example 1

### Using Dough as Second Filling

1) As dough 1, soft flour (50 parts by mass) and water (20 parts by mass) were kneaded using a Kenmix mixer (Kenmix Aicoh Premium, manufactured by AICOHSHA MFG. CO., LTD.).
2) The second filling (dough, 15 g) prepared as above was rolled to 0.4 mm by a pasta machine (Imperia pasta machine, manufactured by Imperia).
3) On the second filling (dough) rolled in 2), the first filling obtained in Preparation Example 1 was placed, then was wrapped by the second filling over the entire surface so that the second filling overlaps as little as possible, and an excessive part of the second filling was cut off with scissors.
4) The fillings obtained in 3) were deep-fried with soybean oil at 175° C. for 3 minutes. As a result, the moisture value of dough 1 was 33.4% by mass.
5) As with normal spring rolls, the fillings obtained in 4) were placed on the skin to shape a spring roll. At least a part of the skin has formed 7 layers.

### Example 2

### Using Skin as Second Filling

1) Using the skin as the second filling, the first filling obtained in Preparation Example 1 was placed on the skin, and the first filling was wrapped with the skin to cover and shape the fillings.
2) The fillings obtained in 1) were deep-fried with soybean oil at 175° C. for 5 minutes. As a result, the water content of the second filling (skin) was 17.6% by mass.
3) The fillings obtained in 2) were further wrapped with the skin to shape a spring roll. At least a part of the skin has formed 7 layers.

### Example 3

### Using a Solid Oil or Fat/Flour Mixture as Second Filling

1) As the second filling, a solid oil or fat/flour mixture was used. First, oil or fat (Melanostar Soft: slip melting point 33° C. to 36° C., manufactured by Fuji Oil Co., Ltd.) were melted in a water bath. Next, medium flour (30 parts by mass) (manufactured by Nippon Flour Mills Co., Ltd.) was added to oil or fat (70 parts by mass), and the mixture was stirred with a whisk until the medium flour became uniform to obtain a solid oil or fat/flour mixture.
2) In order to coat uniformly, the first filling was frozen, and then the mixture (7 g) of solid oil or fat/flour obtained in 1) was used to coat the entire surface of the frozen first filling (25 g).
3) The fillings obtained in 2) were once cooled and hardened in a freezer (−35° C.).
4) The fillings obtained in 3) were placed on the skin to shape a spring roll. At least a part of the skin has formed 7 layers.

### Example 4

### Using a Liquid Oil or Fat/Flour Mixture as Second Filling

1) As the second filling, a liquid oil or fat/flour mixture was used. Nissin canola oil (manufactured by Nisshin OilliO Group, Ltd.) was used as the liquid oil or fat. Soft flour (20 parts by mass) (manufactured by Nisshin Flour Co., Ltd.) was added to liquid oil or fat (80 parts by mass), and the mixture was stirred with a whisk until the soft flour became uniform to obtain a liquid oil or fat/flour mixture.
2) In order to coat uniformly, the first filling was frozen, and then the mixture (7 g) of liquid oil or fat/flour obtained in 1) was used to coat the entire surface of the frozen first filling (25 g).
3) The fillings obtained in 2) were once cooled and hardened in a freezer (−35° C.).
4) The fillings obtained in 3) were placed on the skin to shape a spring roll. At least a part of the skin has formed 7 layers.

The spring rolls obtained in Examples 1 to 4 and Comparative Examples 1 and 2 are shown in Table 1.

TABLE 1

| | |
|---|---|
| Comparative | Spring roll shaped by wrapping the first |
| Example 1 | filling with the skin |
| Comparative | Spring roll shaped by wrapping the first filling with |
| Example 2 | the skin coated by a mixture of rapeseed oil and flour |
| Example 1 | Spring roll shaped by wrapping the fillings, which are |
| | made by coating the first filling with the second |
| | filling (dough) and then deep-fried, with the skin |
| Example 2 | Spring roll shaped by wrapping the fillings, which are |
| | made by coating the first filling with the second |
| | filling (skin) and then deep-fried, with the skin |
| Example 3 | Spring roll shaped by wrapping the fillings, which are |
| | made by coating the frozen first filling over the entire |
| | surface with the second filling (a solid oil or fat/flour |
| | mixture), with the skin |
| Example 4 | Spring roll shaped by wrapping the fillings, which are |
| | made by coating the frozen first filling over the entire |
| | surface with the second filling (a liquid oil or fat/flour |
| | mixture), with the skin |

Evaluation of spring rolls of Examples 1 to 4 and Comparative Examples 1 and 2.

The spring roll shaped products obtained in Examples 1 to 4 and Comparative Examples 1 and 2 were subjected to the following treatment A.

A: The shaped product was deep-fried with soybean oil at 175° C. for 5 minutes, left to stand for 1 minute, and then frozen in a freezer at −18° C. for 30 days. Then, it was reheated in a microwave oven.

### (Measurement of Moisture Value)

The moisture values before and after the deep-frying of the treatment A were measured for the first filling, the second filling, and the skin. The results are shown in Table 2. For the measurement of the moisture value after deep-frying, the spring roll shaped product after deep-frying for 5 minutes in Treatment A was used. Specifically, in order to suppress the change in the moisture value before the measurement, each part of the spring roll obtained by decomposing the shaped product within 5 minutes after deep-frying and frozen at −20° C. was used for the measurement.

TABLE 2

| | | | |
|---|---|---|---|
| Innermost | | | Second |
| layer of | Second | First | filling- |
| skin | filling | filling | First filling |

Moisture value before deep-frying (% by mass)

| | | | | |
|---|---|---|---|---|
| Comparative | 19.0 | — | 85.5 | — |
| Example 1 | | | | |
| Comparative | 19.0 | — | 85.5 | — |
| Example 2 | | | | |
| Example 1 | 19.0 | 33.4 | 85.5 | −52.1 |
| Example 2 | 19.0 | 17.6 | 85.5 | −67.9 |
| Example 3 | 19.0 | 3.4 | 85.5 | −82.1 |
| Example 4 | 19.0 | 2.8 | 85.5 | −82.7 |

Moisture value after deep-frying (% by mass)

| | | | | |
|---|---|---|---|---|
| Comparative | 22.2 | — | 84.5 | — |
| Example 1 | | | | |
| Comparative | 12.7 | — | 81.0 | — |
| Example 2 | | | | |
| Example 1 | 1.7 | 30.3 | 85.3 | −55.0 |
| Example 2 | 1.3 | 13.2 | 82.5 | −69.3 |
| Example 3 | 19.2 | — | 78.8 | — |
| Example 4 | — | — | — | — |

### (Evaluation of Texture)

The texture of the spring rolls after treatment A was evaluated. The evaluation method is as follows. The spring roll shaped products obtained in each Example or each Comparative Example were evaluated in 5 grades by giving 5 points for the crispness of the spring roll skin immediately after deep-frying of the spring roll which was obtained by deep-frying immediately after shaping.

1: No crispness
2: Slight crispness
3: Fair crispness
4: Considerable crispness
5: Crispness equivalent to the spring roll skin immediately after deep-frying of the spring roll which was obtained by deep-frying immediately after shaping

Sensory evaluation was performed by 5 trained panel members. The average score of the 5 panel members is shown in Table 3 as a result. Furthermore, the panel evaluated the spring rolls on the basis that a score of 2.5 or higher was recognized as retaining the typical crispness of spring rolls obtained immediately after deep-frying.

TABLE 3
Crispness

| | |
|---|---|
| Comparative Example 1 | 1.0 |
| Comparative Example 2 | 2.1 |
| Example 1 | 3.6 |
| Example 2 | 4.5 |
| Example 3 | 2.6 |
| Example 4 | 3.4 |

### Example 5

### Using Dough as Second Filling

In Example 5, the spring roll was shaped in the same manner as in Example 1 except that step 4 was drying in an oven (120° C., 5 minutes).

### Example 6

### Using Dough as Second Filling

In Example 6, as dough 2, emulsified oil or fat (50 parts by mass) (Satellite, manufactured by NOF CORPORATION) and water (40 parts by mass) are mixed with a hand mixer (BRAUN MQ500, De′Longhi Japan Corp.) for 1 minute and then kneaded with flour. Here, flour:(emulsified oil or fat+water)=60 parts by mass:35 parts by mass.

In Example 6, the spring roll is shaped in the same manner as in Example 1 except that dough 2 is used as the second filling.

### Example 7

### Using Dough as Second Filling

In Example 7, as dough 3, the dough obtained by adding soybean oil (5 parts by mass) to dough 2 (95 parts by mass) of Example 6 is used.

In Example 7, the spring roll is shaped in the same manner as in Example 1 except that the dough 3 is used as the second filling and that step 4 is drying in an oven (120° C., 5 minutes).

### Example 8

### Using a Mixture of Solid Oil or Fat/Flour as Second Filling

In Example 8, the spring roll was shaped in the same manner as in Example 3 except that in step 2, in order to coat uniformly, the first filling was frozen, and then the mixture (7 g) of solid oil or fat/flour obtained in step 1 was used to coat the bottom surface of the frozen first filling (25 g).

### Example 9

### Using a Mixture of Solid Oil or Fat/Flour as Second Filling

In Example 9, the spring roll was shaped in the same manner as in Example 3 except that in step 2, the mixture (7 g) of solid oil or fat/flour obtained in step 1 was used to coat the bottom surface of the unfrozen first filling (25 g).

1. Fillings for spring rolls, comprising a first filling and a second filling,
wherein at least a part of the surface of the first filling is covered with the second filling, and
wherein the moisture value of the second filling is lower than the moisture value of the first filling.

2. The fillings according to claim 1, wherein the second filling contains a mixture of oil or fat and wheat.

3. The fillings according to claim 1, wherein the second filling contains a kneaded mixture of wheat and water.

4. The fillings according to claim 1, wherein the second filling is a spring roll skin.

5. An unheated spring roll for heat cooking, which is shaped by wrapping the fillings according to claim 1 with a spring roll skin.

6. A heat cooked spring roll, which is a heat cooked product of the spring roll according to claim 5.

7. The spring roll according to claim 5, which is a frozen food.

8. The unheated spring roll for heat cooking according to claim 5, wherein the difference in moisture value between the first filling and the second filling is 40% by mass or more.

9. The heat cooked spring roll according to claim 6, wherein the relationship among moisture values after deep-frying, A (mass %) for the first filling, B (mass %) for the second filling, and C (mass %) for the innermost layer of the spring roll skin, is represented by A>B≥C.

10. A method for producing a spring roll for heat cooking obtained by wrapping fillings with a spring roll skin to shape,
comprising a step of forming fillings,
wherein the fillings include a first filling and a second filling,
wherein at least a part of the surface of the first filling is covered with the second filling, and
wherein the moisture value of the second filling is lower than the moisture value of the first filling, and
wherein the step of forming fillings including a step of covering at least a part of the first filling with the second filling.

11. The production method according to claim 10, wherein the second filling contains a mixture of oil or fat and wheat.

12. The production method according to claim 10, wherein the second filling contains a kneaded mixture of wheat and water.

13. The production method according to claim 10, wherein the second filling is a spring roll skin.

14. The production method according to claim 10, further comprising a step of shaping by wrapping the fillings with a spring roll skin after the step of forming fillings.

15. The production method according to claim 14, wherein the shaping step is a step of shaping a spring roll for heat cooking by wrapping the fillings with a spring roll skin so that at least a part of the spring roll skin has a plurality of layers.

16. The production method according to claim 14, wherein the difference in moisture value between the first filling and the second filling after the shaping step and before deep-fry cooking is 40% by mass or more.

17. A method for retaining crispness of a spring roll skin after deep-fry cooking of a spring roll for heat cooking which is obtained by wrapping fillings with a spring roll skin to shape, wherein the fillings include a first filling and a second filling,
comprising a step of covering the first filling over at least a part of the surface of the first filling with the second filling having a moisture value lower than that of the first filling.
